(19) United States
(12) Patent Application Publication
(10) Pub. No.: US 2016/0117338 A1
(43) Pub. Date: Apr. 28, 2016

(54) SPATIAL INFORMATION SHARING SERVICE SYSTEM USING MULTIPLE IDS AND METHOD THEREOF

(71) Applicant: PAPAYA CORPORATION, Incheon (KR)

(72) Inventors: Won Ik CHOI, Incheon (KR); Young Jun JEON, Yongin-si, Gyeonggi-do (KR)

(21) Appl. No.: 14/897,310

(22) PCT Filed: Apr. 17, 2014
(86) PCT No.: PCT/KR2014/003377

§ 371 Date: Dec. 10, 2015

(30) Foreign Application Priority Data
Jun. 12, 2013 (KR) 10-2013-0067234

(51) Int. Cl. G06F 17/30

(52) U.S. Cl. CPC G06F 17/3087; G06F 17/30241; G06F 17/30377; G06F 17/30867

(57) ABSTRACT

Provided is a system and method for providing a spatial information sharing service by using multiple IDs. The a spatial information sharing service method includes receiving spatial information in association with a user ID of a first user from a first user terminal; and associating and storing the user ID of the first user, an object ID, and the spatial information with one another, wherein the spatial information comprises position information and corresponds to a pair of the user ID and the object ID.

### TECHNICAL FIELD

The following description relates to a system and method for providing a spatial information sharing service.

### BACKGROUND ART

Whenever collecting spatial information, a typical spatial information platform is based on a DB collected unilaterally by a map purpose company. Such a collection method causes a long collection period, may not avoid the batch processing of an update, and leads to a result that has a static spatial DB property. A typical platform has a structure in which the producer and consumer of spatial information are thoroughly isolated, and due to such a structural defect, it is true that needs for map services in various fields are not satisfied.

Due to the recent rapid growth in a social network service (SNS), there is a base on which it is possible to easily create and share text and multimedia information, but geographical spatial information is still static and may only be unilaterally distributed. Thus, it is difficult for an individual to create his or her dynamic geographical space and to share it with others.

In this regard, large companies are attempting an individual-oriented map service in an SNS space but it is inconvenient because invitation or a complicated procedure after mutual pre-recognition should be performed in order to share my location or information of interest with others as needed, so the utilization of the service is low.

### DISCLOSURE OF THE INVENTION

### Technical Problem

Embodiments provide a platform that may create dynamically free spatial information and share the information.

According to an embodiment, a user may freely create and register spatial information with his or her various IDs and use the IDs at various devices to easily share spatial information.

Embodiments also provide a platform that enables spatial information to be continuously added and modified based on personal ownership assigned through an SNS and may maximize sharing with others and distribution.

### Technical Solution

In one embodiment, a spatial information sharing service method includes receiving spatial information in association with a user ID of a first user from a first user terminal; and associating and storing the user ID of the first user, an object ID, and the spatial information with one another, wherein the spatial information includes position information and corresponds to a pair of the user ID and the object ID.

The user ID of the first user may include at least one of a portable phone number and e-mail address of the first user and a specific URL, a plurality of registered user IDs may be maintained in association with the first user, and the received user ID may be one of the plurality of registered user IDs.

The spatial information may further include at least one of text information, multimedia information, and shape information.

The spatial information sharing service method may further include creating the object ID that is not used for the user ID.

The spatial information sharing service method may further include searching for the spatial information corresponding to the user ID and the object ID to provide found spatial information to a second user terminal, when receiving a spatial information request message including the user ID and the object ID from the second user terminal.

The spatial information sharing service method may further include searching for the spatial information corresponding to all object IDs associated with the user ID to provide found spatial information to a second user terminal, when receiving a spatial information request message including the user ID from the second user terminal.

The spatial information sharing service method may further include receiving a modification request for the spatial information associated with the user ID of the first user and the object ID; and modifying the spatial information associated with the user ID and the object ID in response to the modification request for the spatial information.

In another embodiment, a spatial information sharing service system includes a reception unit receiving spatial information in association with a user ID of a first user from a first user terminal; and a registration unit associating the user ID of the first user, an object ID, and the spatial information with one another and storing them in a DB, wherein the spatial information includes position information and corresponds to a pair of the user ID and the object ID.

### Advantageous Effects

Through an embodiment of the preset disclosure, it is possible to provide a spatial information sharing service platform that may dynamically create and easily share free spatial information.

According to an embodiment, a user may freely create and register spatial information with a plurality of IDs and use the

IDs at various devices including a user terminal to easily share spatial information.

According to an embodiment, it is possible to develop various map-based services that may be shared and opened at low costs by using an SNS or portal site and activate global map competitiveness and a map market.

### BRIEF DESCRIPTION OF THE DRAWINGS

FIG. 1 is a diagram for explaining the environment of a system in which a spatial information sharing service method is performed, according to an embodiment of the present disclosure.

FIG. 2 is a block diagram for explaining the internal configuration of a spatial information sharing service system, according to an embodiment of the present disclosure.

FIG. 3 is a diagram for explaining an example where a user ID, an object ID, and spatial information are stored in a DB, according to an embodiment.

FIG. 4 is a diagram for explaining an example of a spatial information request associated with a user ID, according to an embodiment.

FIG. 5 is a diagram for explaining an example of a spatial information request using a user ID and an object ID, according to an embodiment.

FIG. 6 is a flowchart of a spatial information sharing service method according to an embodiment.

### MODE FOR CARRYING OUT THE INVENTION

In the following, a spatial information sharing service system and method is described in detail with reference to the accompanying drawings.

A service system according to an embodiment may provide a service platform that enables a user to freely spatial information and share the information. To this end, multiple IDs may be assigned to a user. Also, it is possible to use the multiple IDs to register various pieces of spatial information with a DB, and when a request for the spatial information registered by the user is received from another user, it is possible to search for spatial information registered with the DB to provide requested spatial information to the other user.

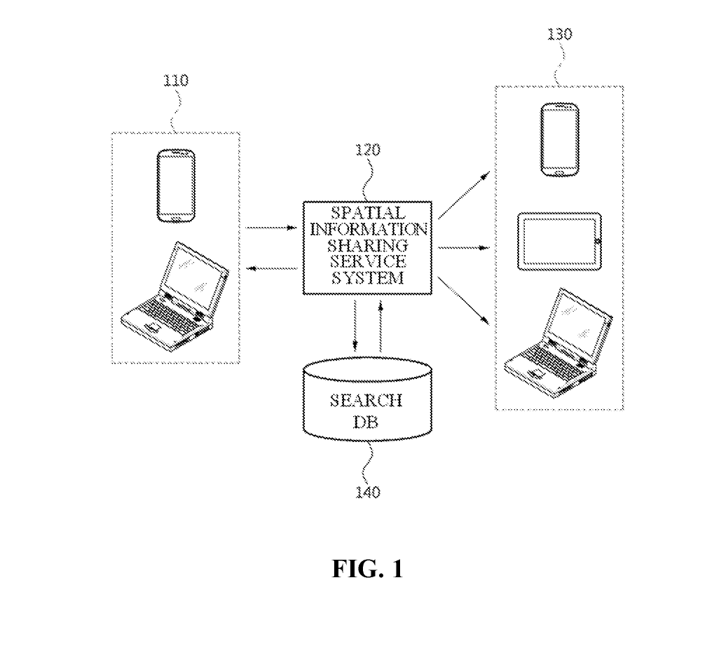

FIG. 1 is a diagram for explaining the environment of a system in which a spatial information sharing service method is performed, according to an embodiment of the present disclosure.

A first user terminal 110 is a user terminal that a first user uses. The first user terminal 110 may request the registration of position information created by the first user, from the spatial information sharing service system 120. The first user terminal 110 may transmit spatial information associated with any one of multiple user IDs and a space and request registration. The spatial information sharing service system 120 may associate the received spatial information with a user ID and an object ID to create a spatial information table, and store the table in a search DB 140. The search DB 140 is a component for storing spatial information in association with the user ID and the object ID, may include both e.g., a commercial DB or non-commercial DB and may be implemented in any forms in order to store spatial information in associate with the user ID and the object ID. The search DB 140 may be included in the spatial information sharing service system 120 or may be provided as an external separate device.

For example, the first user may register a plurality of IDs with the spatial information sharing service system 120. When three IDs “abc5212@gmail.com”, “seawatcher@google.com”, and “010-2424-1234” for the first user are registered with the spatial information sharing service system 120, the first user may select one of the three IDs and request the registration of spatial information from the spatial information sharing service system 120. In this case, the first user may transmit the ID “abc5212@gmail.com” and spatial information (e.g., position information) on his or her favorite cafes to the spatial information sharing service system 120 to request registration. The spatial information may include position information, which may also be an address indicated by text or the position of a specific point selected on an electronic map but is not limited thereto.

The spatial information is information on a space and may include position information. For example, the position information may be GPS information on a specific place, such as a good food restaurant, company, a client, etc. The position information may also be text-style address information or geographical information that includes latitude and longitude information. According to an embodiment, the position information may be the position of the first user terminal 110 that is determined in real time, or an arbitrarily designated position. According to another embodiment, the spatial information may further include at least one of text information, multimedia information, and shape information. The text information is information including text and may include the name, review, homepage URL, etc. of a corresponding place. The multimedia information is information including multimedia and may include a picture or video. The shape information is information on an image and may include a map image. In this case, the first user terminal 110 may transmit the text information, the multimedia information, the shape information, etc. along position information as spatial information to the spatial information sharing service system 120. Then, as second user may receive, from the spatial information sharing service system 120, the text information, the multimedia information, and the shape information in addition to position information in spatial information. Accordingly, other users may also obtain, through spatial information registered by the first user, additional information related to a corresponding position as well as the position. For example, the first user may register text information “My favorite cafes” along with position information on his or her favorite cafes as spatial information with the spatial information sharing service system 120. In this case, other users may also obtain information that the cafes are the first user's favorite cafes, along with position information on the first user's favorite cafes.

The spatial information sharing service system 120 may create an object ID corresponding to the received first user's user ID and spatial information, and associate and store the spatial information with the user ID and the object ID. For example, the first user terminal 110 may transmit the positions of the first user's favorite cafés to “abc5212@gmail.com”, any one of the multiple IDs of the first user and to the spatial information sharing service system 120 to request registration. Then, the spatial information sharing service system 120 may check an object ID that has been already assigned to “abc5212@gmail.com”. In addition, the spatial information sharing service system 120 may assign a new unassigned object ID (e.g., “110”) to the user ID, associate and store the spatial information corresponding to the user ID (e.g., “abc5212@gmail.com”) and the object ID (e.g., “110”) with the spatial information (e.g., the positions of first user's favorite cafes) that has been requested to register. In this case, the first user terminal 110 may receive an object ID corresponding to the spatial information that is designated from the information sharing service system 120.

The second user terminal 130 may request and receive the spatial information registered by another user (e.g., a first user) from the spatial information sharing service system 120. When a spatial information request message is received from the second user terminal 130, the spatial information sharing service system 120 may search the search DB 140 to find corresponding spatial information and transmit the information to the second user terminal 130. For example, the first user provides his or her user ID “abc5212@gmail.com” and an object ID “110” to the second user, indicating that the cafes are my favorite cafes. Then, the second user uses his or her second user terminal 130 to request spatial information corresponding to the user ID “abc5212@gmail.com” and the object ID “110” from the spatial information sharing service system 120. Then, the spatial information sharing service system 120 transmits the spatial information (e.g., the positions of first user's favorite cafes) corresponding to the user ID “abc5212@gmail.com” and the object ID “110” to the second user terminal 130.

In this example, the first user terminal 110 and the second user terminal 130 are different but may be the same depending on the situation. The first user terminal 110 and the second user terminal 120 are not necessarily limited to a single terminal. The first user terminal 110 and the second user terminal 120 are terminal devices that users use, and may include various communication devices, such as a portable phone, tablet PC, notebook computer, navigation device, etc. that are capable of performing wired/wireless network communication.

As another embodiment, when the first user terminal 110 transmits spatial information, it is possible to designate an object ID together. For example, the first user may designate an object ID that is easy to remember personally. It is possible to assign an object ID “my_favorite_cafe” to his or her favorite cafes. For example, the first user terminal 110 may transmit “abc5212@gmail.com”, any one of the multiple IDs of the first user and the positions of first user's favorite cafes along with the object ID “my_favorite_cafe” to the spatial information sharing service system 120 to request registration. Then, the spatial information sharing service system 120 store the spatial information (e.g., the positions of first user's favorite cafes) corresponding to the received user ID (e.g., “abc5212@gmail.com”) and the received object ID (e.g., “my_favorite_cafe”) in a DB.

According to another embodiment, the first user terminal 110 may automatically create an object ID to transmit the object ID to the spatial information sharing service system 120. In this case, the spatial information sharing service system 120 may associate and store the spatial information with the received first user's user ID and the received object ID.

When the object ID received from the first user terminal 110 is already assigned to the user ID (e.g., when object IDs overlap), it is possible to deliver a notification to the first user terminal 110. When the spatial information sharing service system 120 receives an object ID from the first user terminal 110, the spatial information sharing service system 120 determines whether the received object ID is already in use for a designated user ID. If the received object ID is already in use for an user ID, it is possible to notify the first user terminal 110 of related information to request a new object ID from the first user terminal 110. For example, when the first user terminal 110 has transmitted “abc5212@gmail.com”, any one of the multiple IDs of the first user and the positions (spatial information) of first user's favorite cafes along with the object ID “my_favorite_cafe” to the spatial information sharing service system 120 to request registration, and as a result of the check by the spatial information sharing service system 120, the ID “abc5212@gmail.com” is already in use for the object ID “my_favorite_cafe”, the spatial information sharing service system 120 may notify the first user terminal 110 of related information to request a new object ID from the first user terminal 110.

According to an embodiment, it is possible to support multiple IDs as the user ID for spatial information registration. In this case, IDs in various styles associated with the user, such as a portable phone number, an e-mail address or a specific URL may be used as the user ID and may be categorized as needed.

For example, it is possible to use not only a single user ID but also a plurality of user IDs in order to register spatial information with the spatial information sharing service system 120. Users usually maintain a plurality of IDs associated with the users themselves and there may be IDs that they do not want to reveal depending on the other party. In this case, a user may select one of his or her multiple IDs depending on the other party, register and share spatial information with the ID so that it is possible to prevent IDs that he or she does not want to reveal, from becoming shared. For example, when a user's telephone number is used as one of the multiple IDs, it is possible to associate, register, and share the spatial information with the telephone number only when the user wants to share the telephone number.

Also, the user may categorize and register spatial information according to a plurality of user IDs to efficiently manage the spatial information. For example, it is possible to register only spatial information associated with company tasks for the first user ID and only spatial information associated with friends for the second user ID.

The spatial information sharing service system 120 may deliver a notification message on whether reception is normally performed, to the first user terminal 110

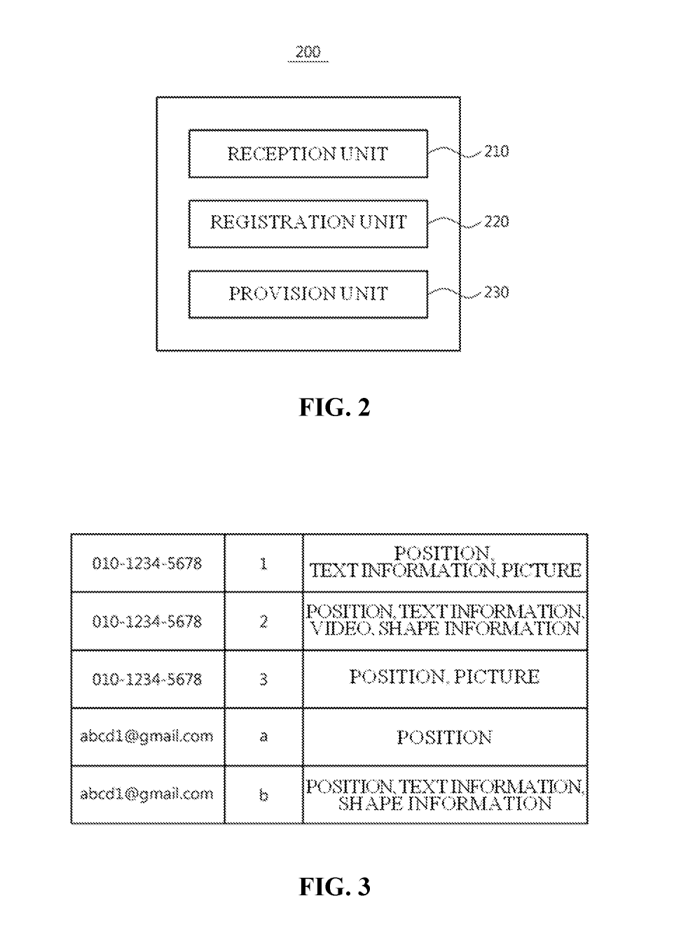

FIG. 2 is a block diagram for explaining the internal configuration of a spatial information sharing service system, according to an embodiment of the present disclosure. A spatial information sharing service system 200 according to an embodiment may include a reception unit 210, a registration unit 220, and a provision unit 230. The reception unit 210, the registration unit 220, and the provision unit 230 may correspond to the internal configuration of the spatial information sharing service system 120 that has been described in FIG. 1.

The reception unit 210 may receive spatial information associated with a user ID of a first user from a first user terminal. According to an embodiment, it is also possible to receive spatial information associated with the user ID of the first user and an object ID designated by the first user. The first user may execute a specific application or web browser at the first user terminal and transmit spatial information associated with the user ID of the first user to the spatial information sharing service system 200. As such, when the spatial information associated with the user ID of the first user is transmitted to the spatial information sharing service system 200, the spatial information sharing service system 200 may receive spatial information through a network that is connected to the spatial information sharing service system 200. In this example, the spatial information may include position information on a place and 1:1 correspond to a pair of a user ID and an object ID.

The user ID is an ID with which it is possible to identify a user, and may include at least one of e.g., a portable phone number, an e-mail address, and a specific URL. The user ID may be registered with the spatial information sharing service system 200 via a user registration process. At least one user ID may be registered and maintained for a user and a plurality of user IDs may also be registered and maintained. Also, one or more object IDs may be stored for a single user ID. The user ID received from the first user terminal may be one of a plurality of registered user IDs.

The registration unit 220 may associate a user ID of a first user, an object ID, and spatial information with one another to store them in a search DB (not shown). The registration unit 220 may store the user ID of the first user and an object ID corresponding to received spatial information together in the search DB. The search DB may associate and store the spatial information with the user ID and the object ID. The search DB may be in the registration unit 220 or provided as an external separate device.

According to an embodiment, the object ID may be created by the spatial information sharing service system 200, in which case the created object ID may be delivered to the first user terminal. In response to the reception of the spatial information, the registration unit 220 may create an unused object ID for a user ID which is received along with the spatial information or with which a log-in operation has been performed, associate and store the object ID with the spatial information. According to an embodiment, the registration unit 220 may create a table of <User ID, Object ID, Spatial Information> and store it in the search DB.

According to an embodiment, when receiving, from a second user terminal, a request message that requests spatial information, the provision unit 230 may provide found spatial information to the second user terminal in response to the request message. When receiving a spatial information request message including the user ID and the object ID from the second user terminal, the provision unit 230 may search for spatial information corresponding to the user ID and the object ID to provide found spatial information to the second user terminal. The spatial information request message may be created through a program or application that is installed in a user terminal. The second user terminal may or may not match the first user terminal. As such, when a single user registers spatial information associated with his or her user ID, other users may use the user ID and the object ID to freely use the spatial information registered by the user and accordingly, it is possible to widely share spatial information.

For example, in the case that spatial information has been registered as shown in FIG. 3, when an user inputs “010-1234-5678/3” to request spatial information, the provision unit 230 may extract a user ID “010-1234-5678” from the request and an object ID “3”. Next, the provision unit 230 may use the user ID “010-1234-5678” and the object ID “3” to search for corresponding spatial information from the search DB and provide found information to a user who has requested it. When the provision unit 230 provides the spatial information, it is possible to provide map information corresponding to position information or provide position information in various styles, such as text information on a position.

According to an embodiment, the provision unit 230 may search for spatial information corresponding to all object IDs associated with the user ID to provide them to the second user terminal, when receiving a spatial information request message including the user ID from the second user terminal. For example, when an user inputs “010-1234-5678” to request spatial information, the provision unit 230 may extract the user ID “010-1234-5678” from the request and determine that an object ID has not additionally been input. In this case, the provision unit 230 may provide the second user terminal with all pieces of spatial information that have been registered in association with the user ID “010-1234-5678”. In this case, it is possible to summary all pieces of spatial information to provide only some information on each of spatial information or it is possible to provide all pieces of spatial information all together.

In FIG. 3, since spatial information that corresponds to the user ID “010-1234-5678” and the object ID “3” includes position information and pictures, the provision unit 230 may provide a user who has requested spatial information, with not only the position information but also the pictures. Additional information, such as pictures may be provided according to a setting that a user has set right information (e.g., information on whether the additional information is together provided) as an option.

FIG. 3 is a diagram for explaining an example where a user ID, an object ID, and spatial information are stored in a DB, according to an embodiment.

A single user may register a plurality of user IDs with a spatial information sharing service system. FIG. 3 shows a case where a single user has registered two user IDs “010-1234-5678” and “abcd1@gmail.com”. As shown in FIG. 3, the user may use his or her portable phone number or e-mail address as the user ID.

There may be a plurality of object IDs for a single user ID, and spatial information corresponding to a pair of a user ID and an object ID may be stored in a search DB. According to an embodiment, the object ID may be created by using a number of character and in a spatial information sharing service system, the object ID may be assigned to the user ID according to a receiving order. For example, when in FIG. 3, a first spatial information request is received in association with the user ID “010-1234-5678”, it is possible to assign an object ID “1”, when a second spatial information request is received in association with the user ID “010-1234-5678”, it is possible to assign an object ID “2”, and when a third spatial information request is received in association with the user ID “010-1234-5678”, it is possible to assign an object ID “3”.

According to another embodiment, a user may designate the object ID. For example, a user may assign an object ID “my_favorite_cafe” to his or her favorite cafe. While receiving “010-1234-5678”, one of multiple IDs of the user from a user terminal and the position (spatial information) of a user's favorite café along with the object ID “my_favorite_cafe”, the spatial information sharing service system may receive the spatial information request message. Then, the spatial information sharing service system 120 may store the spatial information (e.g., the positions of f user's favorite cafes) corresponding to the received user ID (e.g., “010-1234-5678”) and the received object ID (e.g., “my_favorite_cafe”) in a search DB.

In FIG. 3, in association with the user ID “010-1234-5678” of the user, spatial information is stored to correspond to each of the objects IDs “1” to “3”. For example, spatial information including position information on the workplace of the user may be stored to correspond to the object ID “1”, spatial information including position information on the home of the user may be stored to correspond to the object ID “2”, and spatial information including position information on the health club that the user uses may be stored to correspond to the object ID “3”.

The spatial information is information on a space and may include position information. For example, the position information may be GPS information on a specific place, such as a good food restaurant, company, a client, etc. The position information may also be text-style address information or geographical information that includes latitude and longitude information. According to another embodiment, the spatial information may further include at least one of text information, multimedia information, and shape information.

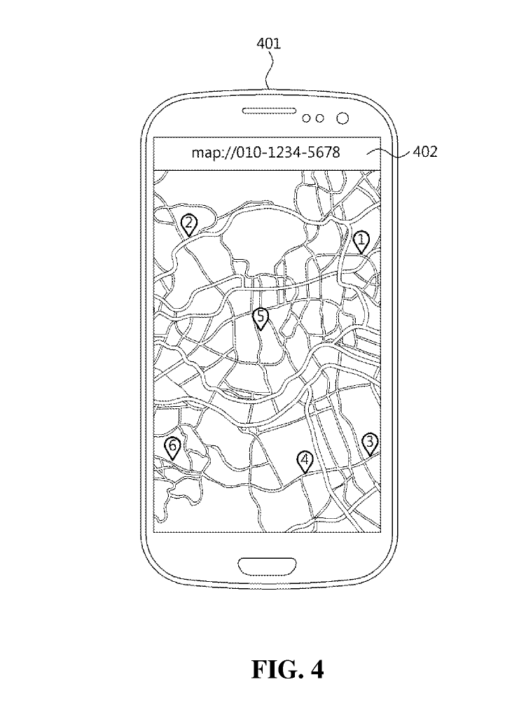

According to an embodiment, the user may request for a search by using the URL format as shown in FIG. 4, when requesting for a search for spatial information that other users have registered. For example, the user may input “map://010-1234-5678/1” to request for spatial information from the spatial information sharing service system. Then, the spatial information sharing service system extracts a user ID and an object ID from the request. In this case, the spatial information sharing service system may determine that “010-1234-5678” corresponds to the user ID and “1” corresponds to the object ID, and search for spatial information corresponding to the user ID and the object ID from a search DB to provide the information to a user terminal of the user. Although the present embodiment describes a case where the user ID and the object ID are input with the URL format, the format in which the user inputs the user ID and the object ID is not limited thereto.

FIG. 4 is a diagram for explaining an example of a spatial information request associated with a user ID, according to an embodiment.

A second user terminal in an embodiment may correspond to a smart phone 401 and deliver a request message to a spatial information sharing service system through an application or browser that is provided with an address search window 402, as shown in FIG. 4. Also, the second terminal may receive a response to the request from the spatial information sharing service system.

In an embodiment, when requesting for a search for spatial information that another user have registered, a user may request all pieces of spatial information corresponding to the user ID by inputting only a user ID of the other user. In this case, spatial information stored in association with all object IDs that correspond to a corresponding user ID may all be provided to the second user terminal. In this case, spatial information on all object IDs may also be displayed on a map image, a list of object IDs in the form of text and spatial information corresponding thereto may also be displayed in a text style.

FIG. 4 shows a case where requested spatial information is displayed in a map image style, includes six object IDs for a user ID “010-1234-5678”, and displays position information indicated by the object IDs as numbers on the screen. According to an embodiment, icons indicating positions may be provided as a link so that detailed descriptions are displayed when the link is selected.

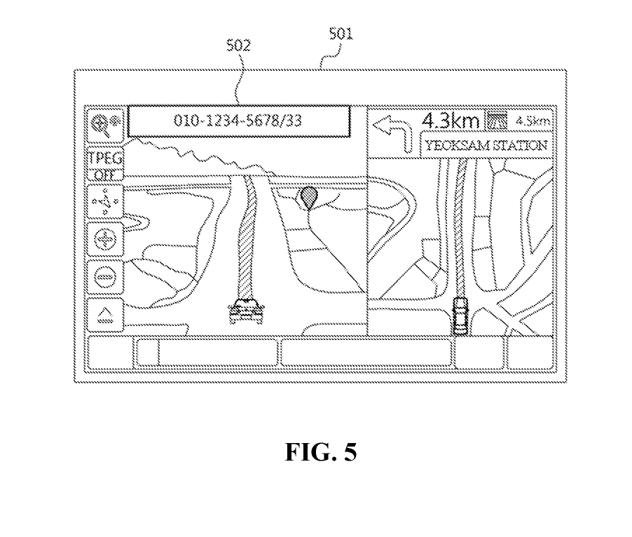

FIG. 5 is a diagram for explaining an example of a spatial information request associated with a user ID and an object ID, according to an embodiment.

In this example, a second user terminal may be provided as a navigation device 501, which may include a function of communicating with a spatial information sharing service system by using a wireless network.

The navigation device 201 may be provided with an address search window 502 and deliver a spatial information request message to the spatial information sharing service system through the address search window 502. When receiving spatial information in response to the request from the spatial information sharing service system, a user may set it as a destination and perform navigation.

In an embodiment, when an user ID and an object ID are together input to the address search window 502 as shown in FIG. 5, it is possible to display spatial information corresponding to a pair of the user ID and the object ID on the screen of the navigation device 501. According to an embodiment, the spatial information may also be displayed in a text style on the navigation device 501.

According to an embodiment, the user may simply share spatial information that other users have registered, and perform navigation setting easily.

When in FIG. 5, only the user ID is input to the address search window 502 as in the embodiment in FIG. 4, the navigation screen of FIG. 5 may be displayed as shown in FIG. 4, in which case the user may select a destination through an operation of clicking a destination icon.

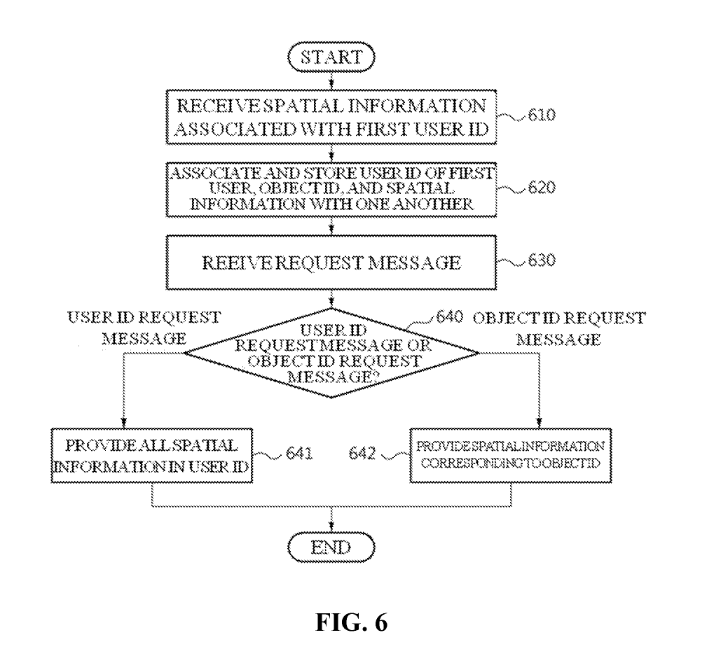

FIG. 6 is a flowchart of a spatial information sharing service method according to an embodiment. The method according to the embodiment may be performed with the configuration of the spatial information sharing service system 200 that has been described in FIGS. 2 to 5.

In step 610, the spatial information sharing service system 200 may receive spatial information associated with a user ID of a first user from a first user terminal. The first user terminal may request the registration of position information created by the first user, from the spatial information sharing service system. The first user terminal may transmit spatial information associated with any one of multiple user IDs of the first user and a space and request registration. The spatial information sharing service system may store, in a search DB, the received spatial information in association with the user ID and an object ID.

The spatial information is information on a space and may include position information. According to another embodiment, the spatial information may further include at least one of text information, multimedia information, and shape information. The text information is information including text and may include the name, review, homepage URL, etc. of a corresponding place. The multimedia information is information including multimedia and may include a picture or video. The shape information is information on an image and may include a map image. In this case, the first user terminal may transmit, as spatial information, the text information, the multimedia information, the shape information, etc. along with position information to the space information sharing service system to request registration. Then, the spatial information sharing service system may also store, as a portion of spatial information, the text information, the multimedia information, and the shape information that that have been requested to register.

According to an embodiment, the spatial information sharing service system 200 may create the object ID that has not been used for the user ID, in response to the reception of spatial information from the first user terminal. For example, when three pieces of spatial information are stored in association with the user ID “010-1234-5678” as shown in FIG. 3 and the spatial information sharing service system 200 has received new spatial information associated with “010-1234-5678” from the first user terminal, the spatial information sharing service system 200 may create an object ID “4” that has not been used for the user ID “010-1234-5678”. In addition, it is possible to store, in a search DB, the new spatial information to correspond to the user ID “010-1234-5678” and the object ID “4” in step S620.

In step 5620, the spatial information sharing service system 200 may store the user ID of the first user and the received spatial information along with the object ID in the search DB. The spatial information includes position information and may be stored in the search DB to correspond to a pair of the user ID and the object ID. In this case, the spatial information sharing service system 200 may register spatial information and then deliver to the first user terminal through a notification that the spatial information has been registered.

In step 630, the spatial information sharing service system 200 may receive a spatial information request message from a second user terminal.

In step S640, the spatial information sharing service system 200 may identify whether the spatial information request message is a request message associated with a user ID or whether it is a request message associated with a user ID and an object ID (including a user ID). In addition, the spatial information sharing service system 200 may provide the second user terminal with spatial information in different forms according to the style of the request message.

When receiving a spatial information request message including the user ID and the object ID from the second user terminal, the spatial information sharing service system 200 may search for spatial information corresponding to the user ID and the object ID to provide found spatial information to the second user terminal.

For example, the received request message may include both the user ID and the object ID, such as “map://abcd1@gmail.com/1” or “map://010-1234-5678/33”. In this case, the spatial information sharing service system 200 may search for spatial information corresponding to a corresponding user ID and an object ID in the search DB to provide found information to the second user terminal as shown in FIG. 5.

When receiving a spatial information request message including the user ID from the second user terminal, the spatial information sharing service system 200 may search for spatial information corresponding to all object IDs associated with the user ID to provide found spatial information to the second user terminal.

For example, the received request message may include only the user ID, such as “map://abcd1@gmail.com” or “map://010-1234-5678”. In this case, the spatial information sharing service system 200 may extract spatial information corresponding to all object IDs included in a corresponding user ID (e.g., “map://abcd1@gmail.com” or “map://010-1234-5678”) from the search DB to provide extracted information to the second user terminal as shown in FIG. 4.

In an embodiment, the spatial information sharing service system 200 may receive a modification request for the spatial information associated with the user ID of the first user and the object ID. In this case, the spatial information sharing service system 200 may modify the spatial information associated with the user ID and the object ID in response to the modification request for the spatial information. For example, when receiving spatial information to be modified along with the user ID and the object ID from the first user terminal, the spatial information sharing service system 200 may modify corresponding spatial information stored in the search DB to store modified information. In response to a subsequent request message, it is possible to deliver modified spatial information. In this way, it is possible to modify spatial information associated with the object ID to the style that a user easily remembers. For example, when the user registers the position of his or her home in association with his or her user ID “abcd1@gmail.com” and an object ID “1” and then moves, it is possible to modify and register spatial information (e.g., the position of his or her home) associated with the user ID “abcd1@gmail.com” and the object ID “1”.

According to an embodiment, when spatial information is registered or modified with the spatial information sharing service system 200, a user authentication procedure may be performed.

Through an embodiment of the preset disclosure, it is possible to provide a spatial information sharing service platform that may create and easily share dynamic, free spatial information. In an embodiment, a user may freely create and register spatial information with a plurality of IDs and easily share spatial information by using only the IDs at various devices including a user terminal.

Also, it is possible to develop various map-based services that may be shared and opened at low costs by using an SNS or portal site and activate global map competitiveness and a map market.

The method according to the embodiment may be implemented in the form of a program command that may be performed through various computer means, and recorded on a computer readable medium. The computer readable medium may include a program command, a data file, a data structure, etc. individually or in combination. The program command recorded on the medium may be specially designed and configured for the embodiment or may also be known to a person who is in charge of computer software. An example of the computer readable recording medium may include magnetic media that includes a hard disk, floppy disk, and magnetic tape, optical media that includes a CD-ROM or DVD, magneto-optical media that includes a floptical disk, and a hardware device, such as a ROM, RAM or flash memory that is specially configured to store and perform a program command. An example of the program command includes high-level language codes that a computer may execute by using an interpreter, as well as a machine language code made by a compiler. The hardware device may be configured to operate as one or more software modules in order to perform the operation of the embodiment and vice versa.

Although embodiments have been described with reference to limited embodiments and the accompanying drawings, a person skilled in the art may implement various modifications and variations from the above description. For example, an appropriate result may be achieved even when the described technologies are performed in different order from the described method, and/or the components of the described system, structure, circuit, etc. are coupled or combined in different forms from the described method or replaced with other components or equivalents.

Therefore, other implementations, other embodiments, and equivalents of the claims also belong to the scope of the claims.

1. A spatial information sharing service method comprising:
receiving spatial information in association with a user ID of a first user from a first user terminal; and
associating and storing the user ID of the first user, an object ID, and the spatial information with one another,
wherein the spatial information comprises position information and corresponds to a pair of the user ID and the object ID.

2. The spatial information sharing service method according to claim 1, wherein the user ID of the first user comprises at least one of a portable phone number and e-mail address of the first user and a specific URL,
a plurality of registered user IDs are maintained in association with the first user, and
the received user ID is one of the plurality of registered user IDs.

3. The spatial information sharing service method according to claim 1, wherein the spatial information further comprises at least one of text information, multimedia information, and shape information.

4. The spatial information sharing service method according to claim 1, further comprising creating the object ID that is not used for the user ID.

5. The spatial information sharing service method according to claim 1, further comprising searching for the spatial information corresponding to the user ID and the object ID to provide found spatial information to a second user terminal, when receiving a spatial information request message comprising the user ID and the object ID from the second user terminal.

6. The spatial information sharing service method according to claim 1, further comprising searching for the spatial information corresponding to all object IDs associated with the user ID to provide found spatial information to a second user terminal, when receiving a spatial information request message comprising the user ID from the second user terminal.

7. The spatial information sharing service method according to claim 1, further comprising:
receiving a modification request for the spatial information associated with the user ID of the first user and the object ID; and
modifying the spatial information associated with the user ID and the object ID in response to the modification request for the spatial information.

8. A spatial information sharing service system comprising:
a reception unit receiving spatial information in association with a user ID of a first user from a first user terminal; and
a registration unit associating the user ID of the first user, an object ID, and the spatial information with one another and storing them in a DB,
wherein the spatial information comprises position information and corresponds to a pair of the user ID and the object ID.

9. The spatial information sharing service system according to claim 8, wherein the user ID of the first user comprises at least one of a portable phone number and e-mail address of the first user and a specific URL,
a plurality of registered user IDs is maintained in association with the first user, and
the received user ID is one of the plurality of registered user IDs.

10. The spatial information sharing service system according to claim 8, further comprising a provision unit that searches for the spatial information corresponding to the user ID and the object ID to provide found spatial information to a second user terminal, when receiving a spatial information request message comprising the user ID and the object ID from the second user terminal.

11. The spatial information sharing service system according to claim 8, further comprising a provision unit that searches for the spatial information corresponding to all object IDs associated with the user ID to provide found spatial information to a second user terminal, when receiving a spatial information request message comprising the user ID from the second user terminal.
